(19) United States
(12) Patent Application Publication
(10) Pub. No.: US 2017/0219747 A1
(43) Pub. Date: Aug. 3, 2017

(54) PATTERN STRUCTURE AND METHOD OF MANUFACTURING THE SAME

(71) Applicant: SAMSUNG ELECTRONICS CO., LTD., Suwon-si (KR)

(72) Inventors: Sunghoon LEE, Seoul (KR); Jaeseung CHUNG, Suwon-si (KR); Dongouk KIM, Pyeongtaek-si (KR); Hyunjoon KIM, Seoul (KR); Joonyong PARK, Suwon-si (KR); Jihyun BAE, Seoul (KR); Bongsu SHIN, Seoul (KR); Dongsik SHIM, Hwaseong-si (KR); Seogwoo HONG, Yongin-si (KR)

(73) Assignee: SAMSUNG ELECTRONICS CO., LTD., Suwon-si (KR)

(21) Appl. No.: 15/337,648

(22) Filed: Oct. 28, 2016

(30) Foreign Application Priority Data
Feb. 1, 2016 (KR) 10-2016-0012457

(51) Int. Cl. G02B 5/18; F21V 8/00; G02F 1/1335

(52) U.S. Cl. CPC G02B 5/1852; G02F 1/133528; G02F 1/133606; G02B 6/0038; G02F 1/133512; G02F 2001/133548

(57) ABSTRACT

A method of manufacturing a pattern structure is provided. The method includes forming a fine pattern on a wafer, cutting the wafer by irradiating the wafer with a laser while changing a focal depth of the laser, thereby forming a unit pattern structure having a fine pattern, and bonding cutting surfaces of at least two unit pattern structures. The cutting of the wafer comprises moving a focal position of the laser in a horizontal direction and changing the focal depth of the laser, such that the unit pattern structure has a cutting surface profile in which a first surface of the unit pattern structure on which the fine pattern is formed protrudes, in a direction substantially parallel to the first surface, from a second surface of the unit pattern structure that is opposite to the first surface.

### CROSS-REFERENCE TO RELATED APPLICATION

This application claims the benefit of Korean Patent Application No. 10-2016-0012457, filed on Feb. 1, 2016, in the Korean Intellectual Property Office, the disclosure of which is incorporated herein in its entirety by reference.

### BACKGROUND

1. Field

Apparatuses and methods consistent with exemplary embodiments relate to a pattern structure and a method of manufacturing the pattern structure, and more particularly, to a large-sized pattern structure having a reduced seam, and a method of manufacturing the pattern structure.

2. Description of the Related Art

The development of liquid crystal displays (LCDs), which are typical display devices, has moved towards the development of larger sized displays with higher resolution and towards the use of such displays in 3D televisions (TVs). To aid in this development, technologies to apply nanoscale functional structures to LCD structures have been introduced. For example, when a nanoscale grating is formed on a surface of a backlight unit located under an LCD panel, light output from the surface of a backlight unit has directivity due to a diffraction phenomenon, which may be used to implement a non-glasses 3D TV. Also, when an absorptive polarization film of an LCD panel is replaced with a wire grid polarizer, the improvement in brightness required to implement a high resolution display may be facilitated.

To apply a nanoscale functional structure to an LCD structure, a technology is needed to form a fine linewidth in the semiconductor-level of a large area in a display level. For example, a tiling technology enables the formation of a large-sized pattern structure by forming a fine structure on a unit pattern structure, on which a semiconductor process can be performed, and physically connecting a plurality of unit pattern structures. However, the tiling technology utilizes a physical bonding method, and therefore, a seam is generated between the unit pattern structures. Accordingly, when a large size nanoscale grating or wire grid polarizer is manufactured using the tiling technology, if the size of a seam is larger than a certain level, a defect may be seen on a screen of the resultant display panel.

### SUMMARY

According to an aspect of an exemplary embodiment, a method of manufacturing a pattern structure includes forming a fine pattern on a wafer, cutting the wafer by irradiating the wafer with a laser while changing a focal depth of the laser, thereby forming a unit pattern structure having the fine pattern, and bonding cutting surfaces of at least two unit pattern structures, in which the cutting of the wafer comprises moving a focal position of the laser in a horizontal direction, substantially parallel to the first surface, and changing the focal depth of the laser, such that the unit pattern structure has a cutting surface profile in which a first surface of the unit pattern structure on which the fine pattern is formed protrudes, in the horizontal direction, from a second surface of the unit pattern structure that is opposite to the first surface.

A first region from the first surface to a first depth in a depth direction may have a vertical cutting surface, substantially perpendicular to the first surface, and a second region from the first depth to the second surface may have a cutting surface that is at least partially inclined with respect to the first surface.

The cutting surface of the first region may protrude farther in the horizontal direction toward an edge of the unit pattern structure than the cutting surface of the second region.

A thickness of the first region may be less than about 150 μm.

The moving of the focal position of the laser in the horizontal direction and the changing the focal depth of the laser may include sequentially changing the focal depth of the laser in a direction from the second surface toward the first surface, and moving the focal position of the laser in the horizontal direction toward the edge of the wafer when the focal depth of the laser is changed.

The sequentially changing of the focal depth of the laser may be performed until the focal depth of the laser reaches the first depth.

The moving of the focal position of the laser may include gradually moving the focal position of the laser in the horizontal direction toward the edge of the wafer whenever the focal depth of the laser is changed.

The moving of the focal position of the laser may include maintaining the focal position of the laser in the horizontal direction until the focal depth of the laser reaches a second depth between the first depth and the second surface, and moving the focal position of the laser in the horizontal direction toward the edge of the wafer while the focal depth of the laser is changed between the second depth and the first depth.

A distance by which the focal position of the laser is moved in the horizontal direction may gradually increase as the focal depth of the laser is moved closer to the first depth and farther from the second depth.

A distance between the first depth and the second depth may be in a range of about 50 μm to about 200 μm.

The bonding of the cutting surfaces of the at least two unit pattern structures may include arranging the at least two unit pattern structures on a substrate, providing photocurable or thermosetting resin in a liquid state between the at least two unit pattern structures, moving the at least two unit pattern structures such that the at least two unit pattern structures closely contact each other, and curing the photocurable or thermosetting resin by irradiation with ultraviolet (UV) light or heat.

The arranging of the at least two unit pattern structures on the substrate may include arranging the at least two unit pattern structures such that the cutting surfaces of the at least two unit pattern structures face each other.

The moving of the at least two unit pattern structures such that the at least two unit pattern structures closely contact each other may include moving the at least two unit pattern structures toward each other such that the cutting surfaces of the at least two unit pattern structures closely contact each other, and distributing the photocurable or thermosetting resin in a liquid state in a gap between the at least two unit pattern structures, above fine patterns of the at least two unit pattern structures, and under second surfaces of the at least two unit pattern structures.

The distributing of the photocurable or thermosetting resin in a liquid state may include providing a base layer to entirely cover the fine patterns of the at least two unit pattern structures, and matching vertical positions of the fine patterns of the at least two unit pattern structures with each other by pressing the base layer towards the at least two unit pattern structures.

The method may further include detaching the base layer from the fine patterns of the at least two unit pattern structures, after the curing of the photocurable or thermosetting resin.

When the base layer is detached, cured resin arranged on the fine patterns of the at least two unit pattern structures may be removed with the base layer, and cured resin arranged in the gap between the at least two unit pattern structures and under the second surfaces of the at least two unit pattern structures may be left.

A gap between the cutting surfaces of the at least two unit pattern structures bonded to each other may be greater than about 0 μm and less than or equal to about 10 μm.

According to an aspect of another exemplary embodiment, a pattern structure includes a first unit pattern structure having a first surface on which a fine pattern is formed and a second surface opposite to the first surface, and a second unit pattern structure having a first surface on which a fine pattern is formed and a second surface opposite to the first surface, and the second unit pattern structure being bonded to the first unit pattern structure, in which the first unit pattern structure and the second unit pattern structure are bonded to each other by a third surface between the first surface and the second surface, and the third surface has a sectional profile in which the first surface where the fine patterns are formed protrudes farther, in a horizontal direction substantially parallel to the first surface, from the second surface.

A first region of the sectional profile extends from the first surface to a first depth in a depth direction and is substantially perpendicular to the first surface. A second region of the sectional profile extends from the first depth to the second surface and is at least partially inclined with respect to the first surface.

The section of the first region may protrude farther in the horizontal direction, toward an edges of the first and second unit pattern structures than the section of the second region.

A thickness of the first region may be within about 150 μm.

The second region from the second surface to the first depth may be inclined as a whole.

A region from the second surface to a second depth between the first depth and the second surface may be substantially perpendicular to the first surface, and a region from the second depth to the first depth may be inclined with respect to the first surface.

The region from the second depth to the first surface may have an inclination that gradually increases from the second depth toward the first depth.

A thickness between the first depth and the second depth may be in a range between about 50 μm to about 200 μm.

The pattern structure may further include a resin layer arranged in a gap between the third surface of the first unit pattern structure and the third surface of the second unit pattern structure and under the second surfaces of the first unit pattern structure and the second unit pattern structure.

A thickness of the resin layer under the second surface of the first unit pattern structure and a thickness of the resin layer under the second surface of the second unit pattern structure may be different from each other such that vertical positions of the first surface of the first unit pattern structure and the first surface of the second unit pattern structure are the same.

The gap between the third surface of the first unit pattern structure and the third surface of the second unit pattern structure may be greater than about 0 μm and less than or equal to about 10 μm.

According to an aspect of another exemplary embodiment, a method of forming a grating using a stamp, the stamp comprising two or more unit pattern regions adjacent to each other and a seam greater than 0 μm and less than or equal to about 10 μm between the adjacent unit pattern regions, each of the unit pattern regions having a pattern, the method includes pressing a resin layer with the stamp such that the resin layer fills complementary patterns of the patterns of the unit pattern regions, curing the complementary patterns of the resin layer, and detaching the stamp from the cured complementary patterns of the resin layer and thereby obtaining the grating having a seam between the complementary patterns greater than 0 μm and less than or equal to about 10 μm.

The stamp further may includes a base layer having a flat surface, and a resin portion disposed on the flat surface of the base layer. The unit pattern regions may be disposed on the resin portion.

The stamp is manufactured using a pattern structure as a master mold. The pattern structure includes a first unit pattern structure having a first surface on which a fine pattern is formed and a second surface opposite to the first surface, and a second unit pattern structure having a first surface on which a fine pattern is formed and a second surface opposite to the first surface, and the second unit pattern structure being bonded to the first unit pattern structure, in which the first unit pattern structure and the second unit pattern structure are bonded to each other by a third surface between the first surface and the second surface, and the third surface has a sectional profile in which the first surface where the fine patterns are formed protrudes farther, in a horizontal direction substantially parallel to the first surface, from the second surface.

The grating may have the same pattern as the fine pattern of the pattern structure.

The stamp may be manufactured by distributing resin for replicating the stamp on the pattern structure, pressing the resin for replicating the stamp by disposing a base layer on the resin for replicating the stamp curing the resin for replicating the stamp, and detaching the base layer from the pattern structure.

The grating may be a grating layer disposed on a surface of a backlight unit for a liquid crystal display or a metal wire pattern of a wire grid polarizer for a liquid crystal display.

The seam of the grating may be disposed directly under a black matrix of the liquid crystal display and may have a width smaller than a width of the black matrix.

### BRIEF DESCRIPTION OF THE DRAWINGS

These and/or other exemplary aspects and advantages will become apparent and more readily appreciated from the following description of the exemplary embodiments, taken in conjunction with the accompanying drawings in which:

FIGS. 1 to 3 are perspective views of a method of manufacturing a large-sized pattern structure by using a tiling technology, according to an exemplary embodiment;

FIG. 4 is a cross-sectional view of a method of forming a unit pattern structure by cutting a wafer, according to an exemplary embodiment;

FIG. 5 is a cross-sectional view of an example of a profile of a cutting surface of the unit pattern structure manufactured by the method of FIG. 4.

FIG. 6 is a schematic cross-sectional view of a state in which two unit pattern structures manufactured by the method of FIG. 4 are bonded to each other;

FIGS. 7 and 8 are schematic cross-sectional views of a method of forming a unit pattern structure by cutting a wafer, according to another exemplary embodiment;

FIGS. 9 to 12 are cross-sectional views of a method of manufacturing a large-sized pattern structure by bonding a plurality of unit pattern structures, according to an exemplary embodiment;

FIGS. 13 and 14 are cross-sectional views of a method of forming a grating layer in a large area on a surface of a backlight unit;

FIG. 15 is a cross-sectional view of a liquid crystal display (LCD) including the backlight unit manufactured by the method illustrated in FIGS. 13 and 14;

FIGS. 16 to 21 are cross-sectional views of a method of forming a large-sized metal wire grid polarizer;

FIG. 22 is a cross-sectional view of an LCD including the metal wire grid polarizer manufactured by the method illustrated in FIGS. 16 to 21; and

FIGS. 23 and 24 are perspective views of large-sized pattern structures manufactured by using a tiling technology, according to other exemplary embodiments.

### DETAILED DESCRIPTION

Reference will now be made in detail to exemplary embodiments which are illustrated in the accompanying drawings, wherein like reference numerals refer to like elements throughout. Also, the size of each layer illustrated in the drawings may be exaggerated for convenience of explanation and clarity. In this regard, the exemplary embodiments may have different forms and should not be construed as being limited to the descriptions set forth herein. Accordingly, the exemplary embodiments are merely described below, by referring to the figures, to explain aspects of the present description. In a layer structure, when a constituent element is disposed “above” or “on” to another constituent element, the constituent element may be only directly on the other constituent element or above the other constituent elements in a non-contact manner.

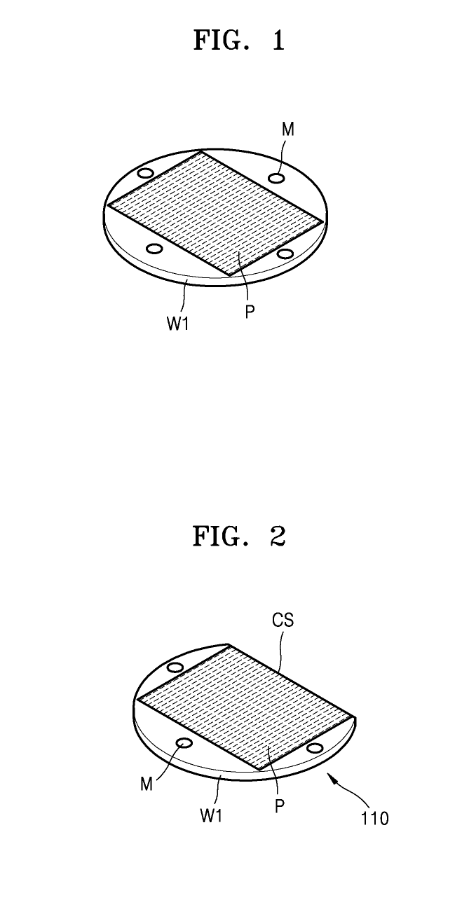

FIGS. 1 to 3 are perspective views of a method of manufacturing a large-sized pattern structure by using a tiling technology, according to an exemplary embodiment.

Referring to FIG. 1, a first wafer W1, on which a fine pattern P is formed, may be provided. The first wafer W1 may be, for example, a silicon wafer. However, the first wafer W1 is not limited to a silicon wafer, and various other wafers such as a compound semiconductor wafer or a sapphire wafer may be selected as desired. The fine pattern P may be formed on the first wafer W1 by using a semiconductor patterning process such as lithography or etching. Also, the fine pattern P may have a nanoscale of, for example, several nanometers to several hundred nanometers, but the present disclosure is not limited thereto. For example, the fine pattern P may have a microscale of several micrometers to several hundred micrometers, as desired.

At least one alignment mark M may also be formed on the first wafer W1. The alignment mark M may be formed in an area of the wafer W1 on which the fine pattern P is not formed. For example, as shown in FIG. 1, the first wafer W1 has a circular shape, and the fine pattern P is formed in a rectangular area on the first wafer W1. A plurality of the alignment marks M may be formed on one or more portions of the wafer W1 which are peripheral to the region on which the fine pattern P is formed. The alignment mark M may be formed by the same process as the fine pattern P when the fine pattern P is formed using a semiconductor process.

Referring to FIG. 2, a unit pattern structure 110, including the fine pattern P may be formed by cutting the first wafer W1. The unit pattern structure 110 may have a cutting surface CS that is formed by cutting the first wafer W1. The cutting surface CS may be a junction surface at which the unit pattern structure 110 is to be coupled to another unit pattern structure 110. Although FIG. 2 illustrates that only one side surface of the first wafer W1 is cut, two or more surfaces may be cut as desired.

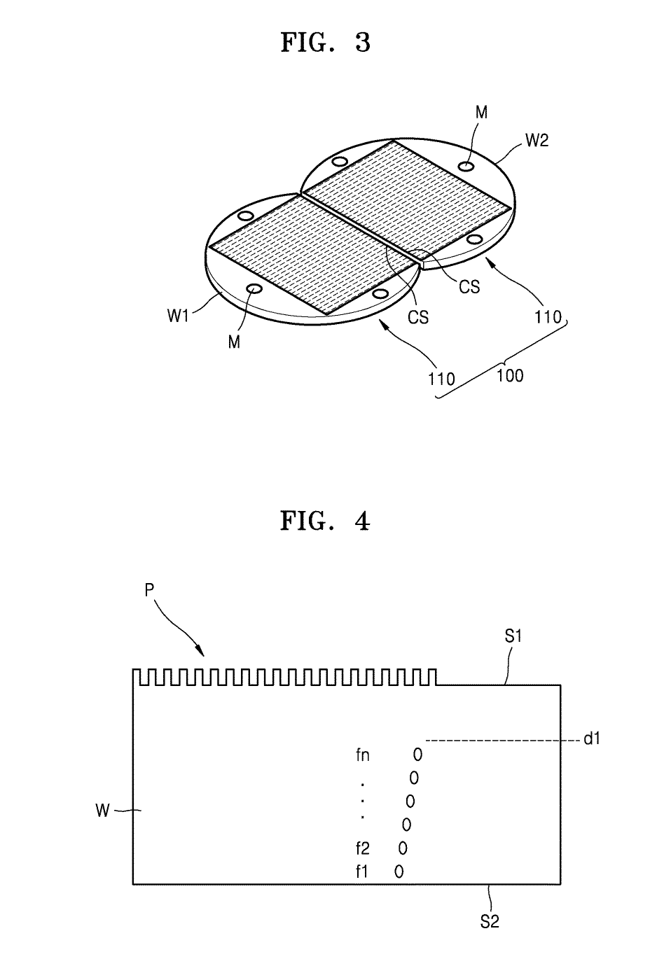

Referring to FIG. 3, a second wafer W2, on which another fine pattern P is formed, may be provided. Then, another unit pattern structure 110 may be further formed by cutting the second wafer W2. The two unit pattern structures 110 are bonded to each other such that the cutting surfaces CS face each other, thereby forming a pattern structure 100. When the two unit pattern structures 110 are bonded to each other, the two unit pattern structures 110 may be precisely aligned by using one or more of the alignment marks M. As a result, the pattern structure 100 of a large size may be manufactured using a tiling method in which two or more unit pattern structures 110 are bonded according to the above-described method.

FIG. 4 is a cross-sectional view of a method of forming the unit pattern structure 110 by cutting the wafer W, according to an exemplary embodiment. Referring to FIG. 4, for example, an edge of the wafer W may be cut by using stealth dicing technology. Stealth dicing technology is a technology in which a silicon wafer is cut using a laser and without surface damage. According to stealth dicing technology, the wafer W may be cut by irradiating the wafer W with a laser by sequentially changing focal depths f1, f2, . . . , and fn of the laser. The stealth dicing technology is suitable for cutting the wafer W without damaging the fine pattern P of the unit pattern structure 110. However, as a result of stealth dicing technology, a roughness of the cutting surface CS is high, and therefore a seam between the unit pattern structures 110 may be increased when the pattern structure 100 is manufactured.

According to an exemplary embodiment, as illustrated in FIG. 4, while performing the stealth dicing, whenever the focal depth (e.g. f1, f2, . . . , and fn) of the laser is changed, the focal position of the laser may be moved in a horizontal direction. In detail, scanning of the laser may proceed from a second surface S2 of the unit pattern structure 110, that is opposite a first surface S1 of the unit pattern structure 110 on which the fine pattern P is formed, in a direction toward the first surface S1. In other words, as the focal depth of the laser is sequentially changed by a certain interval from the first focal depth f1 to the n-th focal depth fn in a direction from the second surface S2 to the first surface S1, a portion of the wafer W may be locally melted. In this state, when the focal depth of the laser is moved toward the first surface S1, the focal position of the laser may be sequentially moved in the horizontal direction toward an edge of the wafer W. For example, the focal position of the laser in the horizontal direction at the second focal depth f2 of the laser is moved farther toward the right, as shown in FIG. 4, than the focal position of the laser in the horizontal direction at the first focal depth f1 of the laser, so as to be closer to the edge of the wafer W. A degree of the movement of the focal position of the laser in the horizontal direction may be several micrometers to several tens of micrometers. As such, because the focal position of the laser in the horizontal direction is moved, the stealth dicing technology as illustrated in FIG. 4 may be referred to as a shift stealth dicing technology.

When the focal depth reaches a certain depth, for example, a first depth d1, while changing the focal depth of the laser according to the above-described method, the scanning of the laser may be stopped. When the focal depth of the laser is close to the first surface S1, a crack may be generated from the focal depth of the laser to the first surface S1 so that the wafer W may be naturally cut without further irradiation of the laser.

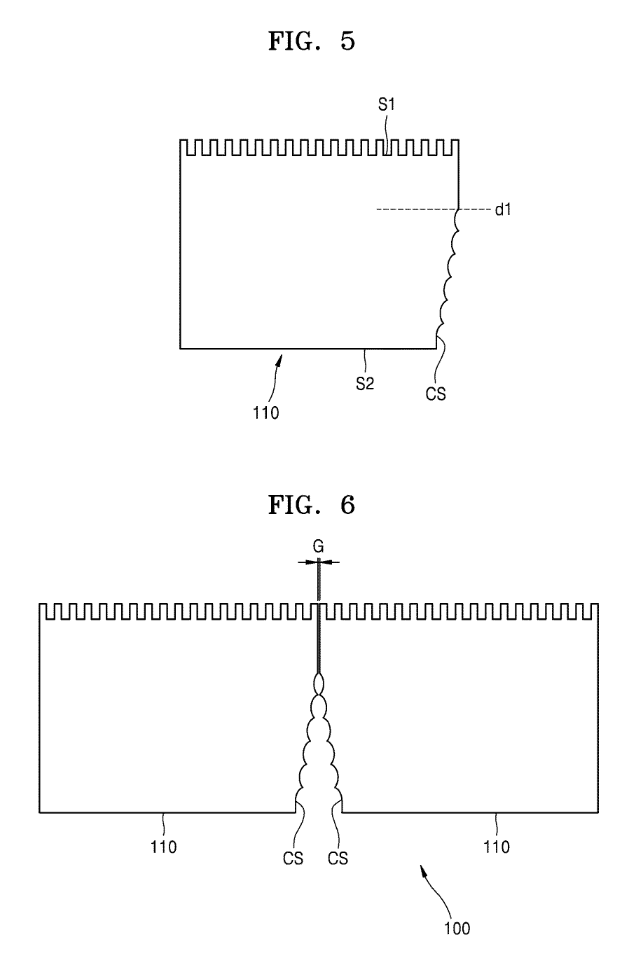

FIG. 5 is a cross-sectional view of an example of a profile of the cutting surface CS of the unit pattern structure 110 manufactured by the method of FIG. 4. Referring to FIG. 5, since the focal position of the laser is moved in the horizontal direction whenever the focal depth of the laser is changed, the profile of the cutting surface CS of the unit pattern structure 110 may have a shape such that the first surface S1, on which the fine pattern P is formed, protrudes farther in the horizontal direction than the second surface S2 that is the opposite side of the first surface S1. In detail, a first region, from the first surface S1 to the first depth d1 in a depth direction, is cut due to the crack that is naturally generated so that a relatively smooth and vertical cutting surface is formed in this first region. A second region, from the first depth d1 to the second surface S2 in the depth direction, may have a cutting surface that is inclined overall. The cutting surface of the second region may not be smooth unlike the first region and but may be rough due to a plurality of melted portions arranged in the depth direction. As illustrated in FIG. 5, the relatively smooth cutting surface of the first region protrudes farther toward the edge of the unit pattern structure 110 than the cutting surface in the second region. The second region may be inwardly concave as compared to the first region, or may include a plurality of concave portions. For example, the first depth d1, and thus a thickness of the first region from the first surface S1 to the first depth d1 in the depth direction, may be within about 150 μm. More specifically, the first depth d1, and thus the thickness of the first region, may be in a range of about 50 μm to about 150 μm.

FIG. 6 is a schematic cross-sectional view of a state in which the two unit pattern structures 110, manufactured by the method of FIG. 4 are bonded to each other. Referring to FIG. 6, the pattern structure 100 of a large size may be formed by bonding to each other the cutting surfaces CS of the two unit pattern structures 110 manufactured by the method of FIG. 4. In this state, the portions of the cutting surfaces CS which are actually bonded are the first regions of the cutting surfaces CS, which protrude farther directions toward the edges of the respective unit pattern structure 110, whereas the second regions of the cutting surfaces CS do not substantially contact each other. Instead, an empty space may be formed between the second regions of the cutting surfaces CS of the two unit pattern structures 110. As such, since the first regions of the cutting surfaces CS, that are relatively smooth, contact each other and the second regions of the cutting surfaces CS, having relatively rough surfaces, do not contact each other, a width of a seam between the two unit pattern structures 110 may be reduced when the pattern structure 100 is manufactured. For example, a gap G, between the cutting surfaces CS of the two unit pattern structures 110 which are bonded to each other, may be greater than 0 μm and equal to or less than 10 μm.

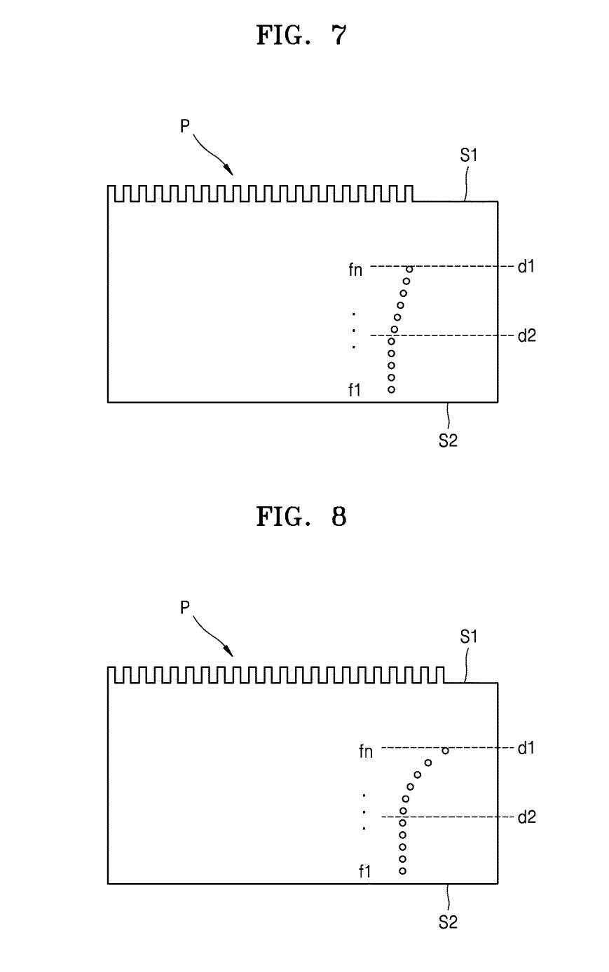

Although, in FIG. 4, whenever the focal depth of the laser is changed toward the first surface S1, the focal position of the laser is described to be gradually moved in the horizontal direction, the present disclosure is not limited thereto. The focal position of the laser may be moved in any method that allows the smooth first regions to protrude and the second regions to be engraved—i.e. recessed with respect to the first regions. For example, FIGS. 7 and 8 are schematic cross-sectional views of a method of forming the unit pattern structure 110 by cutting the wafer W, according to another exemplary embodiment.

Referring to FIG. 7, the scanning of the laser may proceed from the second surface S2 of the unit pattern structure 110 in a direction toward the first surface S1. In this case, the focal position of the laser is not moved in the horizontal direction until the focal depth of the laser reaches a second depth d2 between the first depth d1 and the second surface S2. Then, while the focal depth of the laser is changed between the second depth d2 and the first depth d1, the focal position of the laser may be moved in the horizontal direction toward the edge of the wafer W. Then, the cutting surface CS of the unit pattern structure 110 may have a profile including a relatively smooth vertical surface from the first surface S1 to the first depth d1, a relatively rough inclined surface from the first depth d1 to the second depth d2, and a relatively rough vertical surface from the second depth d2 to the second surface S2. Accordingly, the second region, from the first depth d1 to the second surface S2, may have an at least partially inclined cutting surface. In this case, since the first region of the cutting surface CS of the unit pattern structure 110 protrudes farther than the other regions in a direction toward the edge of the unit pattern structure 110, when the pattern structure 100 is manufactured, the width of a seam between the two unit pattern structures 110 may be reduced. In order to allow the second region of the cutting surface CS of the unit pattern structure 110 to be sufficiently recessed, a distance between the first depth d1 and the second depth d2 may have a range of, for example, about 50 μm to about 200 μm.

Referring to FIG. 8, in order to allow the second region of the cutting surface CS of the unit pattern structure 110 to be further sufficiently recessed, as the focal depth of the laser is closer to the first depth d1 from the second depth d2, a distance by which the focal position of the laser is moved in the horizontal direction may be gradually increased. Then, the cutting surface CS of the unit pattern structure 110 may have an inclined surface having an inclination with respect to the vertical direction that gradually increases from the second depth d2 toward the first depth d1.

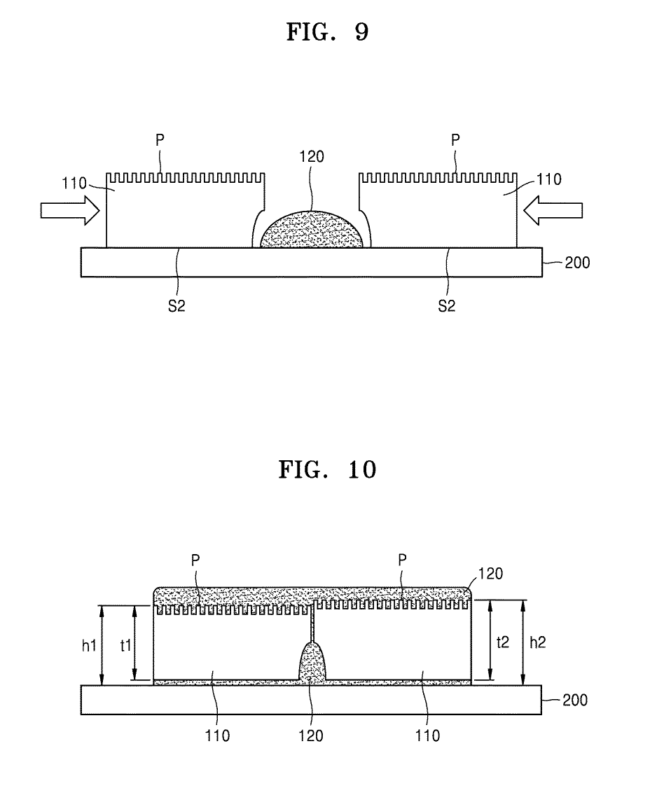

FIGS. 9 to 12 are cross-sectional views of a method of manufacturing the pattern structure 100 of a large size by bonding the unit pattern structures 110, according to an exemplary embodiment.

First, referring to FIG. 9, the unit pattern structures 110 are arranged on a substantially flat substrate 200. The unit pattern structures 110 may be arranged such that the fine pattern P of each of the unit pattern structures 110 faces upward and the second surface S2 of each of the unit pattern structures 110 faces the substrate 200. Although the substrate 200 may be a glass substrate, the present disclosure is not limited thereto and a substrate formed of a plastic material may be employed if the substrate has a flat and smooth surface. Also, resin 120 that is photocurable or thermosetting in a liquid state may be arranged in an empty space between the unit pattern structures 110. For example, the resin 120 may include an acrylate based material. Also, photocompressive or thermocompressive resin instead of photocurable or thermosetting resin may be used as the resin 120. In this case, for example, the resin 120 may include a polyurethane based material.

Next, referring to FIG. 10, the unit pattern structures 110 are arranged such that the cutting surfaces CS of the unit pattern structures 110 may closely contact each other. In doing so, the fine patterns P of the unit pattern structures 110 may be precisely matched with each other by using one or more the alignment marks M (see FIGS. 1-3). When the unit pattern structures 110 closely contact each other, the resin 120 between the unit pattern structures 110 may be distributed in the gap G between the cutting surfaces CS of the unit pattern structures 110, in a gap between the substrate 200 and the second surfaces S2 of the unit pattern structures 110, and over the fine patterns P of the unit pattern structures 110. The resin 120 may have a viscosity lower than, for example, about 1000 cps so that the resin 120 may be easily distributed.

As illustrated in FIG. 10, the thicknesses of the two unit pattern structures 110 may not be completely identical to each other due to a deviation in the manufacturing process. For example, the unit pattern structure 110 at the left side of FIG. 10 may have a thickness of t1, whereas the unit pattern structure 110 at the right side of FIG. 10 may have a thickness of t2. In this case, the fine pattern P of the unit pattern structure 110 at the left side may be located at a height of h1 and the fine pattern P of the unit pattern structure 110 at the right may be located at a height of h2, different from h1, as shown.

Referring to FIG. 11, a base layer 130 is arranged above the resin 120 distributed on the fine patterns P of the unit pattern structures 110. The base layer 130 ultimately functions as a support portion for a stamp and may be formed of, for example, a plastic material such as polyethylene terephthalate (PET). The base layer 130 may be arranged such that a flat surface of the base layer 130 contacts the resin 120. The base layer 130 is pressed by a pressing layer 140 from above. Although FIG. 11 illustrates a pressing layer 140 that is wide and flat, the present disclosure is not limited thereto and, for example, the base layer 130 may be pressed toward the substrate 200 by rolling a cylindrical press roller over the base layer 130.

When the base layer 130 is pressed toward the unit pattern structures 110, the resin 120 distributed between the base layer 130 and the unit pattern structures 110 may function as a buffer member for preventing damage to the fine pattern P. Also, the resin 120 distributed between the substrate 200 and the unit pattern structures 110 may function as a compensation layer for adjusting the heights of the fine patterns P of the two unit pattern structures 110. For example, when the base layer 130 is pressed by the pressing layer 140, the thickness of the resin 120 distributed between the substrate 200 and the unit pattern structures 110 may vary such that pressure respectively acting on the base layer 130 and the two unit pattern structures 110 is equalized. In this way, the fine patterns P of the two unit pattern structures 110 may be aligned at the same height h. In other words, positions in a vertical direction of the fine patterns P of the two unit pattern structures 110 may be equalized in this way such that they match each other. Accordingly, the thickness of the resin 120 under the second surfaces S2 of the unit pattern structures 110 may partially vary. For example, a portion of the resin 120 under the unit pattern structure 110 at the left side in FIG. 11 may have a thickness t3, whereas a portion of the resin 120 under the unit pattern structure 110 at the right in FIG. 11 may have a thickness t4.

After the positions of the fine patterns P of the unit pattern structures 110 are matched with each other in the vertical direction, heat or light, for example, ultraviolet (UV) light, is applied to the resin 120. Although FIG. 11 illustrates that heat or light is applied in a direction from the substrate 200 toward the resin 120, the direction in which heat or light is applied is not particularly limited. For example, in the case in which the base layer 130 is formed of a transparent material with respect to a visible light or a UV light, the pressing layer 140 is removed and then heat or light may be applied in a direction from the base layer 130 to the resin 120. Alternatively, heat or light may be applied in a direction toward a side of the unit pattern structure 110. Then, the resin 120 is cured by a cross link reaction so that the two unit pattern structures 110 that are adjacent to each other may be bonded to each other. Also, when the resin 120 is photocompressive or thermocompressive resin, a solvent in the resin 120 is vaporized and thus the resin 120 that is photocompressive or thermocompressive is compressed so that the adjacent two unit pattern structures 110 may be bonded to each other.

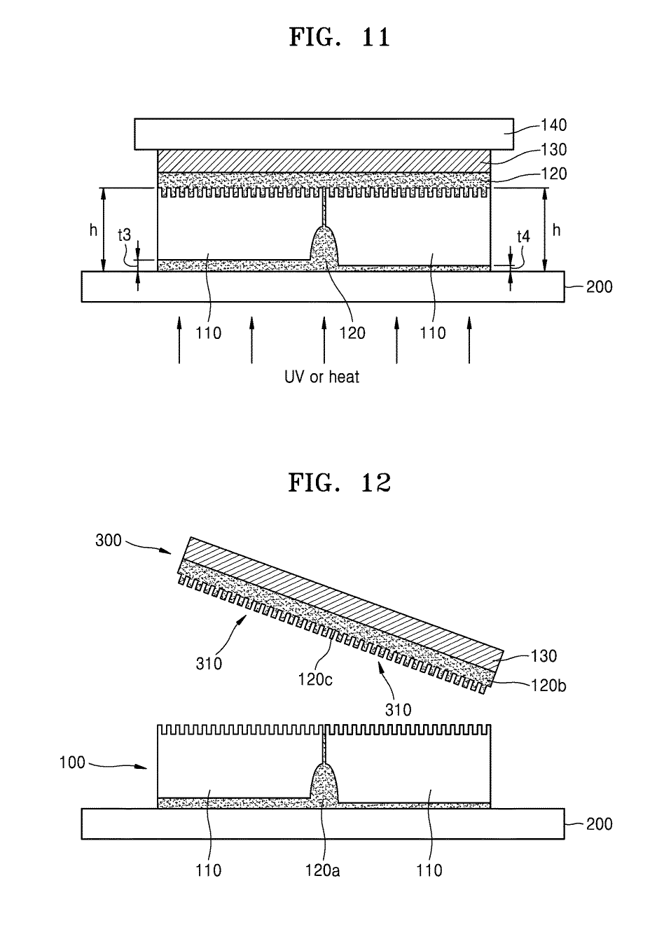

Referring to FIG. 12, the base layer 130 is removed after the resin 120 is cured. In this state, a resin portion 120b distributed over the fine pattern P of the unit pattern structures 110 is detached, along with the base layer 130, from the fine pattern P of the unit pattern structures 110. A resin portion 120a distributed in the gap G between the cutting surfaces CS of the unit pattern structures 110 and the gap between the substrate 200 and the second surfaces S2 of the unit pattern structures 110 remains in the pattern structure 100 formed by bonding the unit pattern structures 110. In particular, an intermediate portion 120c having a thin thickness of the resin 120 inserted between the fine patterns P above the gap G between the cutting surfaces CS of the unit pattern structures 110 may be detached with the base layer 130 from the pattern structure 100. As such, the resin portion 120b attached on the base layer 130 has a pattern which is complementary to the fine patterns P. Accordingly, the base layer 130 and the resin portion 120b that are detached in FIG. 12 may function as a stamp 300 for imprinting a fine pattern using an imprint technology. The stamp 300 may include at least two unit pattern regions 310 adjacent to each other on the resin portion 120b, which respectively correspond to the unit pattern structures 110. Each of the unit pattern regions 310 has a pattern which is complementary to the fine patterns P of its corresponding unit pattern structure 110. The intermediate portion 120c may be a seam between the two adjacent unit pattern regions 310.

The pattern structure 100 manufactured in the above-described method may function as a master mold for replicating the stamp 300. For example, similar to the above-described method, after resin for replicating a stamp is additionally distributed on the fine pattern P of the pattern structure 100, the base layer 130 may be arranged on the resin for replicating a stamp and pressed, and the resin for replicating a stamp may be cured and then the base layer 130 may be detached from the patter structure 100, thereby replicating the stamp 300. In other words, in a process of manufacturing the pattern structure 100 that is a master mold, a single stamp 300 may be manufactured and the stamp 300 may be additionally replicated in a subsequent additional process. In particular, according to the method illustrated in FIGS. 9 to 12, since the gap G between the cutting surfaces CS of the unit pattern structures 110 is already completely filled with the resin 120, an intrusion of the resin used for the replication of a stamp into the gap G between the cutting surfaces CS of the unit pattern structures 110 in the subsequent stamp replication process may be prevented.

The intermediate portion 120c, having a thin thickness, inserted between the fine patterns P above the gap G between the cutting surfaces CS of the unit pattern structures 110 may be a defect in the stamp 300 by which a seam may be seen. However, as described above, since the gap G between the cutting surface CS of the unit pattern structures 110 is very small and equal to or less than about 10 μm, the intermediate portion 120c existing in a seam portion may be sufficiently covered by a black matrix of a display panel. Accordingly, when a fine pattern is imprinted by using the pattern structure 100 and the stamp 300 manufactured according to the present exemplary embodiment, the seam portion is not seen because it is covered with the black matrix of a display panel and thus a defect in the display panel may be avoided.

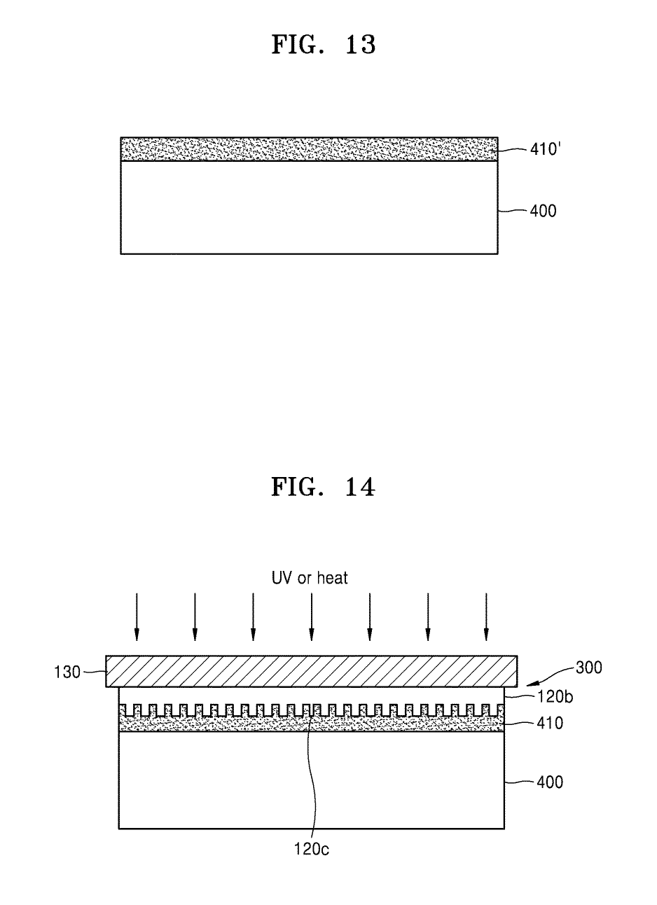

For example, FIGS. 13 and 14 are cross-sectional views of a method of forming a grating layer in a large area on a surface of a backlight unit 400 by using the above-described stamp 300.

First, referring to FIG. 13, a resin layer 410′ is formed on the backlight unit 400. A surface of the backlight unit 400 may be a light-exit surface through which light exits. For example, in a case in which the backlight unit 400 is a direct type of backlight unit, the resin layer 410′ may be formed on a light diffusion plate of the backlight unit 400. Also, in a case in which the backlight unit 400 is an edge type of backlight unit, the resin layer 410′ may be formed on a light-exit surface of a light guide plate. The resin layer 410′ may include, for example, photocurable, thermosetting, photocompressive, or thermocompressive resin.

Referring to FIG. 14, the resin layer 410′ is pressed, from above, to be compressed by the stamp 300. The stamp 300 may be manufactured as illustrated in FIG. 12 or may alternately be additionally by using the pattern structure 100 as a master mold. The stamp 300 may be arranged such that the resin portion 120b, having a complementary pattern, faces the resin layer 410′. Then, the resin layer 410′, having flexibility, fills in the complementary patterns of the resin portion 120b. In this state, when light, for example, UV light, or heat is applied to the resin layer 410′, the resin layer 410′ is cured. After the resin layer 401′ is completely cured, the stamp 300 may be detached from the resin layer 410′. Then, a grating layer 410 may be formed on the surface of the backlight unit 400. The grating layer 410 formed as described above may have the same pattern as the fine pattern P of the pattern structure 100.

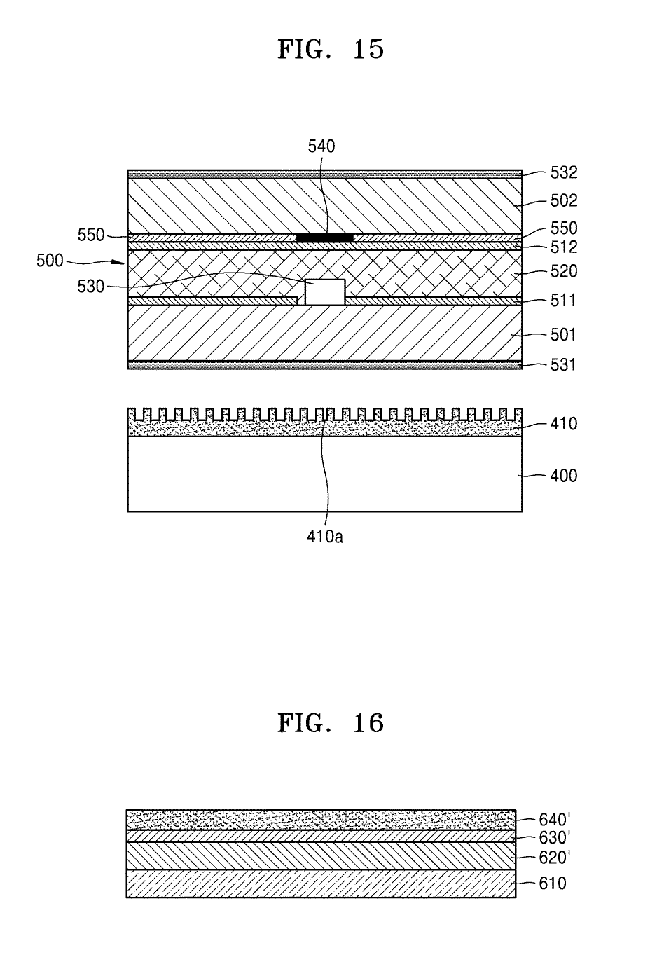

FIG. 15 is a cross-sectional view of a liquid crystal display (LCD) 500 including the backlight unit 400 manufactured by the method illustrated in FIGS. 13 and 14. Referring to FIG. 15, the LCD 500 may include a first substrate 501 and a second substrate 502, which are spaced apart from each other, a liquid crystal layer 520 disposed in a space between the first substrate 501 and the second substrate 502, and the backlight unit 400 for emitting light toward the liquid crystal layer 520. Also, a plurality of first electrodes 511 and a plurality of thin film transistors 530, connected to the first electrodes 511 and controlling an operation of the liquid crystal layer 520, are disposed on the first substrate 501. The first electrodes 511 may include a pixel electrode provided for each pixel of the LCD 500. Also, a second electrode 512, functioning as a common electrode, is disposed on the second substrate 502. A plurality of color filters 550 are disposed between the second substrate 502 and the second electrode 512 to correspond to the first electrodes 511. The color filters 550 may each transmit light having a particular color, for example, red, green, or blue. A black matrix 540 is formed between the color filters 550. The black matrix 540 may prevent cross talk between the pixels and improve contrast by blocking light. Also, a first polarizing panel 531 and a second polarizing panel 532 may be disposed on outer surfaces of the first and second substrates 501 and 502, respectively. The first polarizing panel 531 and the second polarizing panel 532 may be polyvinyl alcohol (PVA) polarizing panels that are absorptive polarizing panels, but the present disclosure is not limited thereto. For an LCD 500 having the above-described structure, since the grating layer 410 provided on the backlight unit 400 allows light to proceed in a specific direction for each pixel, a three-dimensional image in a non-glasses method may be implemented.

As exemplarily illustrated in FIG. 15, the grating layer 410 transferred onto the surface of the backlight unit 400 may have a seam portion 410a corresponding to a seam portion of the pattern structure 100. In the LCD 500 according to the present exemplary embodiment, the seam portion 410a of the grating layer 410 may be arranged at a position corresponding to the black matrix 540. In detail, the seam portion 410a of the grating layer 410 is located directly under the black matrix 540. As described above, a width of the seam portion 410a of the grating layer 410, for example, less than or equal to 10 μm, may be smaller than a width of the black matrix 540. As such, when the seam portion 410a, having a width that is smaller than that of the black matrix 540, is located under the black matrix 540, the seam portion 410a covered by the black matrix 540 is not visible, and thus, a flawless, large image may be displayed.

Also, a large-sized metal wire grid polarizer may be formed by using the above-described pattern structure 100 and stamp 300. For example, FIGS. 16 to 21 are cross-sectional views of a method of forming a large-sized metal wire grid polarizer by using the stamp 300.

First, referring to FIG. 16, a metal layer 620′, a hard mask 630′, and a resin layer 640′ are sequentially formed on and above a support substrate 610. For example a transparent glass substrate or a transparent polymer substrate, which are capable of transmitting visible light, may be used as the support substrate 610. For example, a metal material having conductivity, such as, gold (Au), silver (Ag), copper (Cu), aluminum (Al), etc. may be used as the metal layer 620′, but the present disclosure is not limited thereto. The hard mask 630′ may include a hard material. The resin layer 640′ may include a flexible photocurable or thermosetting material.

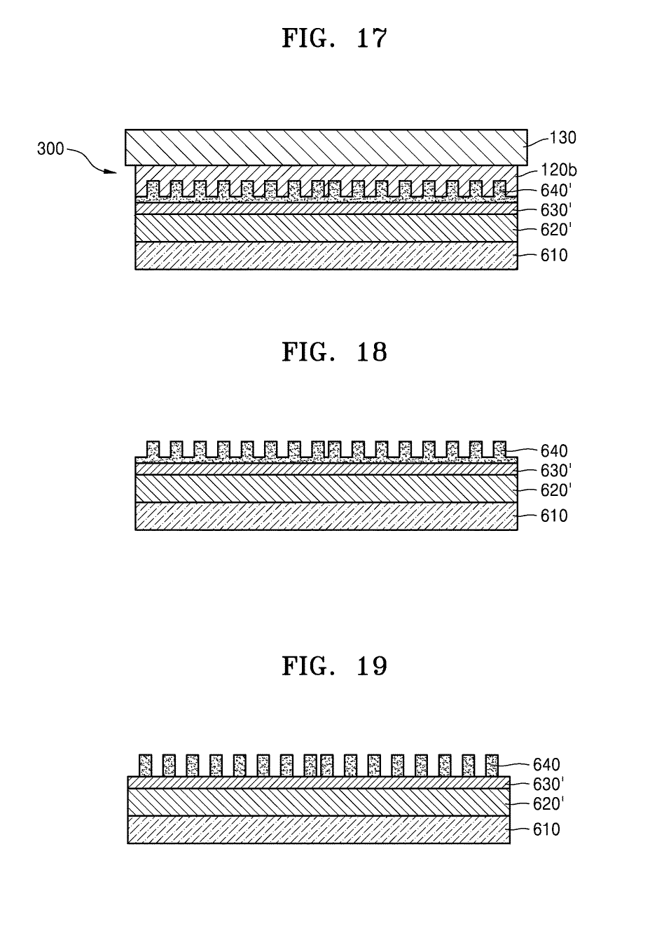

Next, referring to FIG. 17, the stamp 300 is pressed against the resin layer 640′ so as to closely contact each other. The stamp 300 may be manufactured as illustrated in FIG. 12 or may be additionally manufactured, using the pattern structure 100 as a master mold. The stamp 300 may be arranged such that the resin portion 120b, having a complementary pattern, faces the resin layer 640′. Then, the resin layer 640′, having flexibility, fills in the complementary patterns of the resin portion 120b. In this state, when light, for example, UV light, or heat is applied to the resin layer 640′, the resin layer 640′ is cured. Next, the stamp 300 is detached from the resin layer 640′ and thus, as illustrated in FIG. 18, a patterned resin layer 640 is formed on the hard mask 630′.

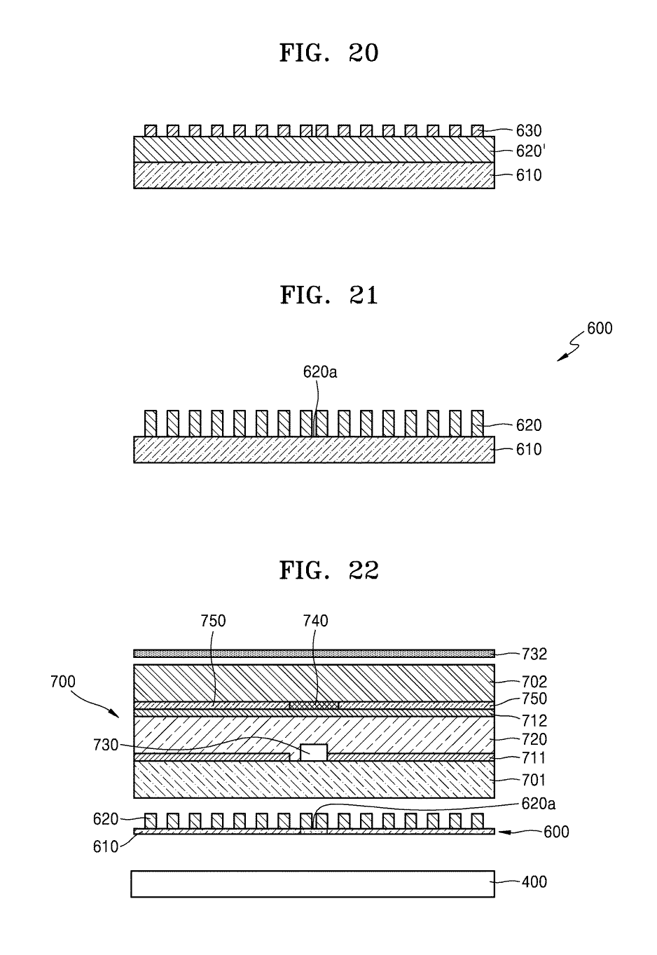

Referring to FIG. 19, an etching process is performed by using the patterned resin layer 640 as a mask and thus a resin material remaining on the hard mask 630′ is removed. Referring to FIG. 20, the hard mask 630′ is patterned by using the patterned resin layer 640 as a mask, and then the patterned resin layer 640 is removed. Then, a patterned hard mask 630 may be formed on the metal layer 620′.

Then, referring to FIG. 21, the metal layer 620′ is patterned by using the patterned hard mask 630 as a mask, and then the patterned hard mask 630 is removed. Then, a metal wire grid polarizer 600, including a plurality of metal wire patterns 620 provided on the support substrate 610, may be completed. The metal wire patterns 620 may have the same pattern as the fine pattern P of the pattern structure 100. Accordingly, as illustrated in FIG. 21, a seam portion 620a corresponding to a seam portion of the pattern structure 100 may be formed in a middle portion of the metal wire patterns 620.

FIG. 22 is a cross-sectional view of an LCD 700 including the metal wire grid polarizer 600 manufactured by the method illustrated in FIGS. 16 to 21. Referring to FIG. 22, the LCD 700 may include a first substrate 701 and a second substrate 702, a liquid crystal layer 720 disposed in a space between the first substrate 701 and the second substrate 702, and the backlight unit 400, providing light toward the liquid crystal layer 720. Also, as described in FIG. 15, the LCD 700 may further include first electrodes 711, thin film transistors 730, a second electrode 712, color filters 750, and a black matrix 740.

The LCD 700 may further include the metal wire grid polarizer 600 facing the first substrate 701 and an absorptive polarizing panel 732 facing the second substrate 702. Although FIG. 22 illustrates that the absorptive polarizing panel 732 faces the second substrate 702 and the metal wire grid polarizer 600 is faces the first substrate 701, the present disclosure is not limited thereto and the positions of the absorptive polarizing panel 732 and the metal wire grid polarizer 600 may be reversed. The metal wire grid polarizer 600 characteristically reflects light that is polarized in a direction parallel to the metal wire patterns 620 and transmits light that is polarized in a direction perpendicular to the metal wire patterns 620. For example, the metal wire grid polarizer 600 may reflect an S-polarized wave and transmit a P-polarized wave. Accordingly, when the metal wire grid polarizer 600 is used, a reflected S-polarized wave is reused and thus loss of light may be reduced and brightness of the LCD 700 may be improved.

As exemplarily illustrated in FIG. 22, the metal wire patterns 620 of the metal wire grid polarizer 600 may have a seam portion 620a corresponding to the seam portion of the pattern structure 100. In the LCD 700 according to the present exemplary embodiment, the seam portion 620a of the metal wire patterns 620 may be disposed in a position corresponding to the position of black matrix 740. As described above, a width, for example, 10 μm or less, of the seam portion 620a of the metal wire patterns 620 may be smaller than the width of the black matrix 740. When the seam portion 620a, having a width smaller than the width of the black matrix 740, is located facing the black matrix 740, the seam portion 620a, covered by the black matrix 740, is not visible and thus a flawless, large image may be displayed.

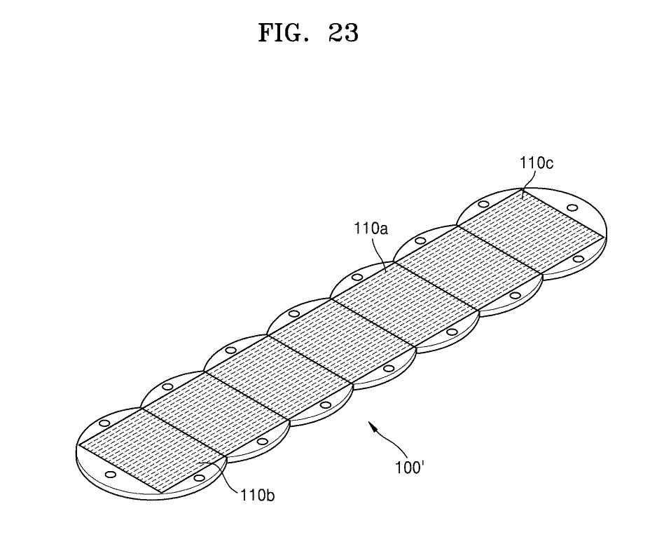

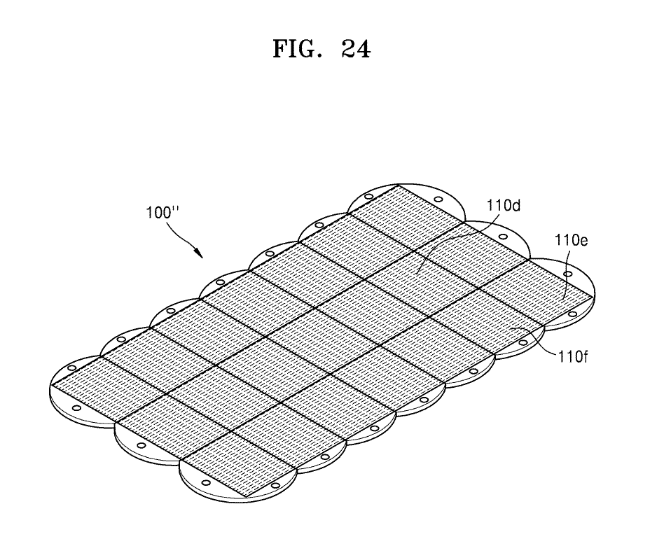

Although an example of manufacturing the pattern structure 100 by bonding two unit pattern structures 110 is described above, the pattern structure 100 may be manufactured in a larger size by bonding three or more unit pattern structures 110. The number of the unit pattern structures 110 to be bonded may be variously determined according to a size of the wafer W to be used in a semiconductor patterning process and a size of the pattern structure 100 to be implemented. For example, FIGS. 23 and 24 are perspective views of large-sized pattern structures 100′ and 100″ manufactured by using a tiling technology, according to other exemplary embodiments.

Referring to FIG. 23, the large-sized pattern structure 100′ may be manufactured by linearly bonding a plurality of unit pattern structures 110a, 110b, and 110c. In FIG. 23, when the unit pattern structures 110a located in the middle portion of the large-sized pattern structure 100′ are manufactured, opposite edge sides of a wafer may be cut in the method illustrated in FIG. 4, 7, or 8. However, when the unit pattern structures 110b and 110c located at opposite ends of the large-sized pattern structure 100′ are manufactured, only one edge side of the wafer may be cut in the method illustrated in FIG. 4, 7, or 8. Then, after all unit pattern structures 110a, 110b, and 110c are arranged on a single substrate 200 of FIG. 9, the pattern structure 100′ may be manufactured in the method illustrated in FIGS. 9 to 12. After the pattern structure 100′ is completed, as desired, the other edge sides of the wafer where the alignment marks M are located may be removed. When the alignment mark M is removed, a stealth dicing technology or another dicing technology may be employed.

Referring to FIG. 24, the large-sized pattern structure 100″ may be manufactured by arranging a plurality of unit pattern structures 110d, 110e, and 110f in two-dimensions and bonding the unit pattern structures 110d, 110e, and 110f to one another. In FIG. 24, when the unit pattern structure 110d, that is to be arranged completely inside the large-sized pattern structure 100″, is manufactured, all four sides of each wafer therein may be cut in the method illustrated in FIG. 4, 7, or 8. Also, when the unit pattern structures 110e, that are to be located at the four corners of the large-sized pattern structure 100″, are manufactured, two neighboring edge sides of each wafer may be cut in the method illustrated in FIG. 4, 7, or 8. When the unit pattern structures 110f, to be arranged along a side of the large-sized pattern structure 100″, are manufactured, three edge sides of each wafer therein may be cut in the method illustrated in FIG. 4, 7, or 8. Then, after all unit pattern structures 110d, 110e, and 110f are arranged on a single substrate 200 of FIG. 9, the pattern structure 100″ may be manufactured in the method illustrated in FIGS. 9 to 12.

It should be understood that the exemplary embodiments regarding the pattern structure and the method of manufacturing the pattern structure described herein should be considered in a descriptive sense only and not for purposes of limitation. Descriptions of features or aspects within each embodiment should typically be considered as available for other similar features or aspects in other exemplary embodiments.

While one or more exemplary embodiments have been described with reference to the figures, it will be understood by those of ordinary skill in the art that various changes in form and details may be made therein without departing from the spirit and scope as defined by the following claims.

What is claimed is:

1. A method of manufacturing a pattern structure, the method comprising:
forming a fine pattern on a wafer;
cutting the wafer by irradiating the wafer with a laser, thereby forming a unit pattern structure having the fine pattern; and
bonding cutting surfaces of at least two unit pattern structures,
wherein the cutting the wafer comprises repeatedly irradiating the wafer with the laser and repeatedly moving a focal position of the laser in a horizontal direction and changing a focal depth of the laser, thereby forming a cutting surface profile in the unit pattern structure such that a first surface of the unit pattern structure on which the fine pattern is formed protrudes in the horizontal direction with respect to a second surface of the unit pattern structure that is opposite the first surface.

2. The method of claim 1, wherein a first region of the cutting surface profile extends from the first surface to a first depth in a depth direction and has a cutting surface that is substantially perpendicular to the first surface, and a second region of the cutting surface profile extends from the first depth to the second surface and has a cutting surface that is at least partially inclined with respect to the first surface.

3. The method of claim 2, wherein the cutting surface of the first region protrudes farther in the horizontal direction toward an edge of the unit pattern structure than the cutting surface of the second region.

4. The method of claim 2, wherein a thickness of the first region, from the first surface to the first depth, is not greater than about 150 μm.

5. The method of claim 2,
wherein the moving the focal position of the laser in the horizontal direction and changing the focal depth of the laser comprises:
sequentially changing the focal depth of the laser in a direction from the second surface toward the first surface; and
moving the focal position of the laser in the horizontal direction toward the edge of the wafer when the focal depth of the laser is changed.

6. The method of claim 5, further comprising stopping the sequentially changing the focal depth of the laser when the focal depth of the laser reaches the first depth.

7. The method of claim 5, wherein the moving the focal position of the laser comprises gradually moving the focal position of the laser in the horizontal direction toward the edge of the wafer whenever the focal depth of the laser is changed.

8. The method of claim 5, wherein the moving the focal position of the laser comprises:
maintaining the focal position of the laser in the horizontal direction until the focal depth of the laser reaches a second depth between the first depth and the second surface; and
moving the focal position of the laser in the horizontal direction toward the edge of the wafer while the focal depth of the laser is changed between the second depth and the first depth.

9. The method of claim 8, wherein a distance by which the focal position of the laser is moved in the horizontal direction gradually increases as the focal depth of the laser is moved closer to the first depth and farther from the second depth.

10. The method of claim 8, wherein a distance between the first depth and the second depth is in a range of about 50 μm to about 200 μm.

11. The method of claim 1, wherein the bonding of the cutting surfaces of the at least two unit pattern structures comprises:
arranging the at least two unit pattern structures on a substrate;
providing a resin in a liquid state between the at least two unit pattern structures;
moving the at least two unit pattern structures such that the at least two unit pattern structures closely contact each other; and
curing the resin, wherein the resin comprises one of a photocurable resin and a thermosetting resin.

12. The method of claim 11, wherein the arranging of the at least two unit pattern structures on the substrate comprises arranging the at least two unit pattern structures such that the respective cutting surfaces of the at least two unit pattern structures face each other.

13. The method of claim 12, wherein the arranging of the at least two unit pattern structures such that the at least two unit pattern structures closely contact each other comprises:
moving the at least two unit pattern structures toward each other such that the respective cutting surfaces of the at least two unit pattern structures closely contact each other; and
distributing the resin in the liquid state in a gap between the at least two unit pattern structures, above fine patterns of the at least two unit pattern structures, and under second surfaces of the at least two unit pattern structures.

14. The method of claim 13, wherein the distributing of the resin in the liquid state comprises:
positioning a base layer such that the base layer entirely covers the fine patterns of the at least two unit pattern structures; and
matching vertical positions of the respective fine patterns of the at least two unit pattern structures with each other by pressing the base layer toward the at least two unit pattern structures.

15. The method of claim 14, further comprising detaching the base layer from the fine patterns of the at least two unit pattern structures, after the curing of the resin.

16. The method of claim 15, wherein the detaching the base layer comprises removing, with the base layer, a first portion of the cured resin arranged on the fine patterns of the at least two unit pattern structures, and separating the first portion of the cured resin from a second portion of the cured resin arranged in the gap between the at least two unit pattern structures and under the second surfaces of the at least two unit pattern structures.

17. The method of claim 1, wherein a gap between the cutting surfaces of the at least two unit pattern structures bonded to each other is greater than about 0 μm and less than or equal to about 10 μm.

18. A pattern structure comprising:
a first unit pattern structure comprising a first surface, on which a fine pattern is formed, a second surface opposite to the first surface, and a third surface extending from the first surface to the second surface; and
a second unit pattern structure comprising a first surface, on which a fine pattern is formed, a second surface opposite to the first surface, and a third surface extending from the first surface to the second surface,
wherein the third surface of first unit pattern structure is bonded to the third surface of the second unit pattern structure,
wherein, in each of the first unit pattern structure and the second unit pattern structure, the third surface has a sectional profile in which the first surface protrudes, in a horizontal direction substantially parallel to the first surface, with respect to the second surface.

19. The pattern structure of claim 18, wherein, in each of the first unit pattern structure and the second unit pattern structure, a first region of the section profile extends from the first surface to a first depth in a depth direction and is substantially perpendicular to the first surface, and a second region of the section profile extends from the first depth to the second surface and is at least partially inclined.

20. The pattern structure of claim 19, wherein in each of the first unit pattern structure and the second unit pattern structure, the section profile of the first region protrudes farther in a direction toward an edge of the respective unit pattern structure than the section profile of the second region.

21. The pattern structure of claim 19, wherein, in each of the first unit pattern structure and the second unit pattern structure, a thickness of the first region is less than about 150 μm.

22. The pattern structure of claim 19, wherein, in each of the first unit pattern structure and the second unit pattern structure, the section profile in the second region is inclined as a whole.

23. The pattern structure of claim 19, wherein, in each of the first unit pattern structure and the second unit pattern structure, a portion of the section profile in the second region, extending from the second surface to a second depth between the first depth and the second surface, is substantially vertical with respect to the first surface, and a portion of the section profile in the second region extending from the second depth to the first depth, is inclined with respect to the first surface.

24. The pattern structure of claim 23, wherein in ach of the first unit pattern structure and the second unit pattern structure, the portion of the section profile in the second region extending from the second depth to he first depth has an inclination that gradually increases from the second depth toward the first depth.

25. The pattern structure of claim 23, wherein in each of the first unit pattern structure and the second unit pattern structure, a thickness between the first depth and the second depth is in a range between about 50 μm to about 200 μm.

26. The pattern structure of claim 18, further comprising a resin layer disposed in a gap between the third surface of the first unit pattern structure and the third surface of the second unit pattern structure and under the second surfaces of the first unit pattern structure and the second unit pattern structure.

27. The pattern structure of claim 26, wherein a thickness of the resin layer under the second surface of the first unit pattern structure is different than a thickness of the resin layer under the second surface of the second unit pattern structure, and a position of the first surface of the first unit pattern structure and a position of the first surface of the second unit pattern structure are equal in a vertical direction, substantially normal to the first surface of the first unit pattern structure and the first surface of the second unit pattern structure.

28. The pattern structure of claim 26, wherein the gap between the third surface of the first unit pattern structure and the third surface of the second unit pattern structure is greater than about 0 μm and less than or equal to about 10 μm.

29. A method of forming a grating using a stamp, the stamp comprising two or more unit pattern regions adjacent to each other and a seam greater than 0 μm and less than or equal to about 10 μm between the adjacent unit pattern regions, each of the unit pattern regions having a pattern, the method comprising:
pressing a resin layer with the stamp such that the resin layer fills complementary patterns of the patterns of the unit pattern regions;
curing the complementary patterns of the resin layer; and
detaching the stamp from the cured complementary patterns of the resin layer and thereby obtaining the grating having a seam between the complementary patterns greater than 0 μm and less than or equal to about 10 μm.

30. The method of claim 29, wherein the stamp further comprising:
a base layer having a flat surface; and
a resin portion disposed on the flat surface of the base layer,
wherein the unit pattern regions are disposed on the resin portion.

31. The method of claim 29, wherein the stamp is manufactured using a pattern structure as a master mold, the pattern structure comprising:
a first unit pattern structure comprising a first surface, on which a fine pattern is formed, a second surface opposite to the first surface, and a third surface extending from the first surface to the second surface; and
a second unit pattern structure comprising a first surface, on which a fine pattern is formed, a second surface opposite to the first surface, and a third surface extending from the first surface to the second surface,
wherein the third surface of first unit pattern structure is bonded to the third surface of the second unit pattern structure,
wherein, in each of the first unit pattern structure and the second unit pattern structure, the third surface has a sectional profile in which the first surface protrudes, in a horizontal direction substantially parallel to the first surface, with respect to the second surface.

32. The method of claim 31, wherein the grating has the same pattern as the fine pattern of the pattern structure.

33. The method of claim 31, wherein the stamp is manufactured by:
distributing resin for replicating the stamp on the pattern structure;
pressing the resin for replicating the stamp by disposing a base layer on the resin for replicating the stamp;
curing the resin for replicating the stamp; and
detaching the base layer from the pattern structure.

34. The method of claim 29, wherein the grating is a grating layer disposed on a surface of a backlight unit for a liquid crystal display or a metal wire pattern of a wire grid polarizer for a liquid crystal display.

35. The method of claim 29, wherein the seam of the grating is disposed directly under a black matrix of the liquid crystal display and has a width smaller than a width of the black matrix.
